(19) United States
(12) Patent Application Publication
(10) Pub. No.: US 2019/0059322 A1
(43) Pub. Date: Feb. 28, 2019

(54) Novel pet feeder

(71) Applicant: ShenZhen BenKei Technology co.,Ltd, Shenzhen (CN)

(72) Inventor: Yanjiao XU, Shenzhen (CN)

(21) Appl. No.: 15/812,890

(22) Filed: Nov. 14, 2017

(30) Foreign Application Priority Data
Aug. 29, 2017 (CN) 201721142232.6

(51) Int. Cl. A01K 5/02; A01K 7/02

(52) U.S. Cl. CPC A01K 5/0225; A01K 7/02

(57) ABSTRACT

The utility model discloses a novel pet feeder, comprising a base, a shell body, a discharging system, a material bucket, and a water bottle; the base consists of a base shell, a food disk and a water disk; the front side of base shell is provided with a buckle hook plugged in a chute arranged on the food disk; the shell body is fixed on the base; the shell body is composed of a front shell, a back shell, a handle and a control panel. The novel pet feeder can realize remote and accurate feeding control and instant video signaling of good vision by means of a terminal device; the grain discharging condition also can be monitored in real time and effectively controlled, The improved material stirring system makes food discharge more accurately. The effective anti-blocking mechanism can guarantee the normal discharge of food.

### FIELD OF THE INVENTION

The utility model belongs to the mechatronic engineering field, and particularly relates to a novel pet feeder.

### BACKGROUND OF THE INVENTION

The existing pet feeder only can manually control feeding, and cannot carry out the remote control; the existing intelligent feeder is weak in structure design or structure reliability, or incapable of effectively preventing blockage and realizing food detection and accurate feeding; or the operation is relatively complex; moreover, some existing pet feeders separate food feeding from water feeding. For this reason, we design the novel pet feeder.

### DESCRIPTION OF INVENTION

The utility model provides a novel pet feeder in order to solve the problems abovementioned.

The utility model is realized through the following technical scheme:

A novel pet feeder, which comprises a base, a shell body, a discharging system, a material bucket, and a water bottle; the base consists of a base shell, a food disk and a water disk; the front side of the base shell is provided with a buckle hook and the buckle hook is plugged in a chute arranged on the food disk; the shell body is fixed on the base; the shell body is composed of a front shell, a back shell, a handle and a control panel; both sides of the front shell and the back shell are provided with installing holes of which dimensions are just matched with the handle, and the handle is just blocked by the combination of the front shell and the back shell; a control panel component is fixed on the front shell; a discharging system is installed inside the shell body; the top of the discharging system is connected with the material bucket; a water bottle is fixed on the handle through a buckle.

As the further optimization scheme of the utility model, the discharging system comprises a discharging bracket, a discharging roller slot, a discharging frequency detecting module, a motor, and a motor fixing cover; the upper end of the discharging bracket can be spaced with the material bucket to guarantee the mutual cooperation, food can smoothly enter the top part; the discharging roller slot is installed in the cavity body of the discharging bracket; the discharging frequency detecting module is installed on the discharging opening of the discharging bracket; a material stirring piece is installed in the discharging roller slot and rotated under the driving of a motor; a specific rectangular asymmetrical structure of the material stirring piece can make the food lay off smoothly; a rotary shaft of the material stirring piece is connected with a food feeding counter and a food feeding starter; when the motor is rotated at 45 degrees, the device is triggered to feed; the motor is counted once for every rotation and stops rotation when the preset grid number is reached; a motor protecting cover is arranged on the motor and fixed on the inside of the shell body.

As the further optimization scheme of the utility model, the material bucket sleeves on the shell body, and comprises a bucket cover, a material bucket light guide arm cover, a lower material bucket, and a discharging connection component; the bucket cover is of flip type, and the switch is of pressing retreat type, namely, the button is pressed down and an extended buckle position is internally contracted; meanwhile, the cover is opened and then closed, thus the bucket cover is pressed; the buckle position is buckled again under the spring pressure after the buckle position is internally contracted; the material bucket light guide arm cover and the lower material bucket are connected through a screw; the lower part of the material bucket light guide arm cover is equipped with a light guide pillar and an LED lamp; through the specific angle at 45 degrees, the upper part of the whole material bucket is lighted; the lower material bucket is matched with the shell body through the buckle position and the guide groove, and can be taken out in the process of filling food; a silica gel pad is embedded to the upper part of the material bucket light guide arm cover for ensuring the tightness in the material bucket.

As the further optimization scheme of the utility model, the food disk and the water disk can be detached for cleaning; the bottom shell is provided with two power supply methods of three 5# batteries and DC direct plug-in; when the DC direct plug-in stops working, the battery is automatically started to supply power; a water nozzle sleeve of the water bottle is a stainless steel pipe, and two steel beads are placed therein as water outlet switches.

Compared with the prior art, the utility model has the beneficial effects that the novel pet feeder can carry out remote and accurate feeding control and instant video signaling of good vision by means of a terminal device; meanwhile, the grain discharging condition also can be monitored in real time and effectively controlled, and manual quantitative feeding can be selected. The structure is stable with great road holding performance; the improved material stirring system makes the food discharge more accurately. The effective anti-blocking mechanism can guarantee the normal discharge of food, and carry out self protection under emergency. Moreover, the novel pet feeder can offer multifunctional reasonable feeding and more convenient and smarter pet cultivation way.

### DESCRIPTION OF ATTACHED FIGURES

FIG. 1 is structure diagram of the utility model;

FIG. 2 is an understructure structure diagram of the utility model;

FIG. 3 is a shell structure diagram of the utility model;

FIG. 4 is a discharging system structure diagram of the utility model;

FIG. 5 is a material bucket structure diagram of the utility model;

FIG. 6 is a water bottle structure diagram of the utility model;

FIG. 7 is a structure front view of the utility model;

FIG. 8 is a structure side view of the utility model;

FIG. 9 is a structure vertical view of the utility model;

In the figure: 1, base; 2, shell body; 3, discharging system; 4, material bucket; 5, water bottle; 1-1, bottom shell; 1-2, food disk; 1-3, water disk; 2-1, front shell; 2-2, back shell; 2-3, handle; 2-4, control panel component; 3-1, discharging bracket; 3-2, discharging roller slot; 3-3, motor fixing cover; 3-4, material stirring piece; 4-1, bucket cover; 4-2, material bucket light guide arm cover; 4-3, lower material bucket.

### SPECIFIC EMBODIMENT MODE

The attached figure below and the specific embodiment mode can further introduce the utility model in details:

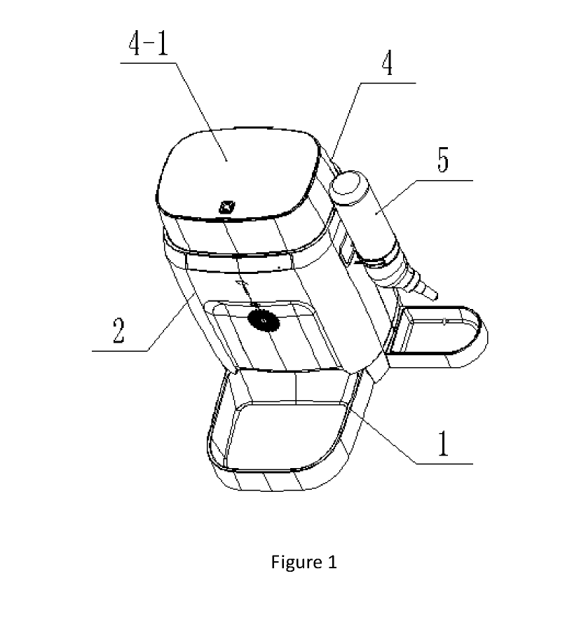

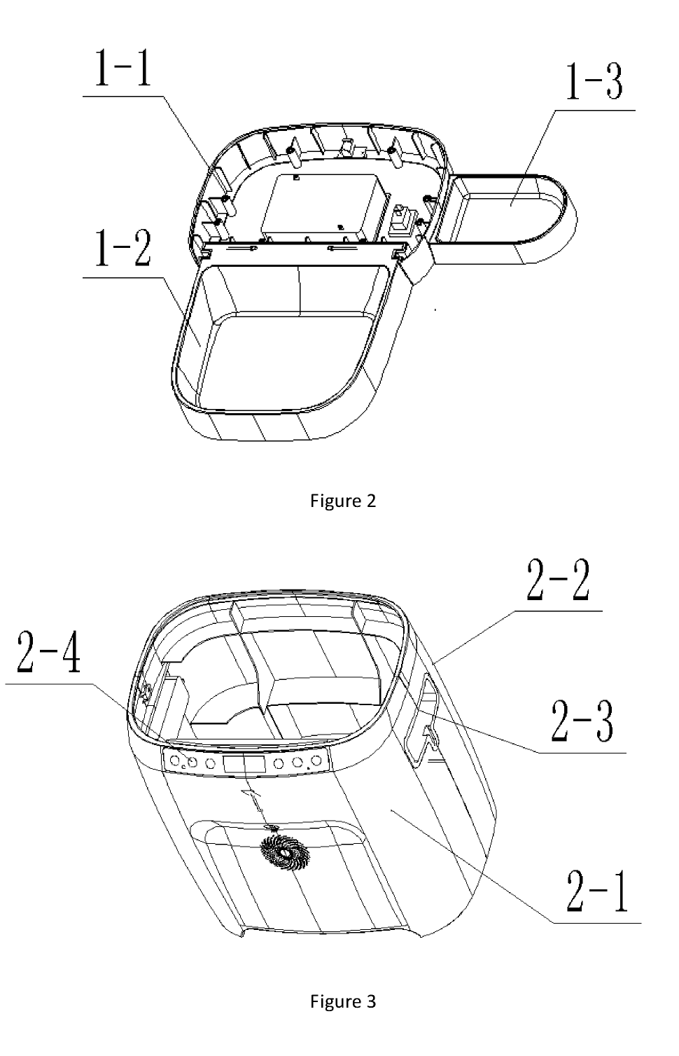

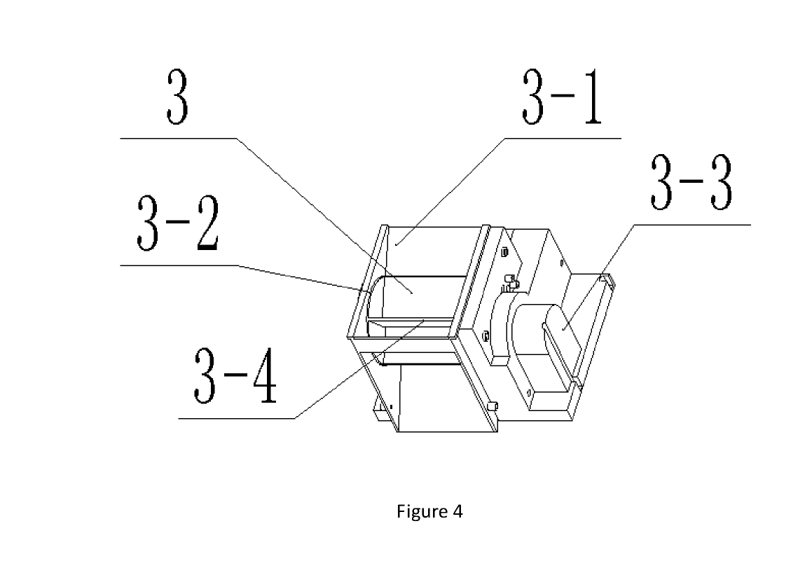

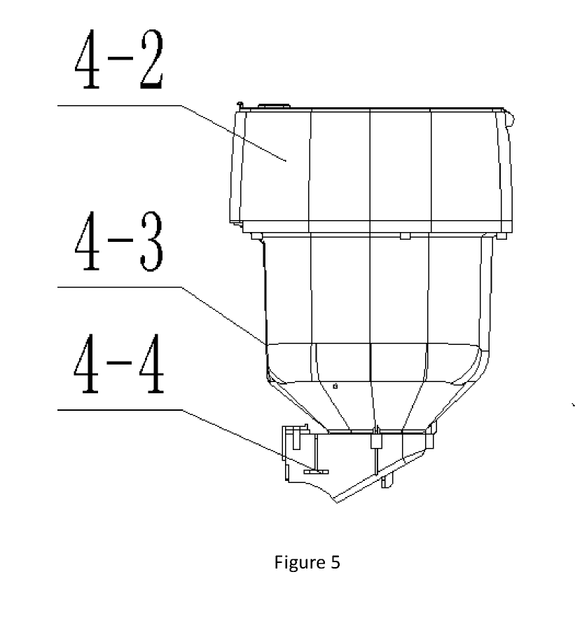

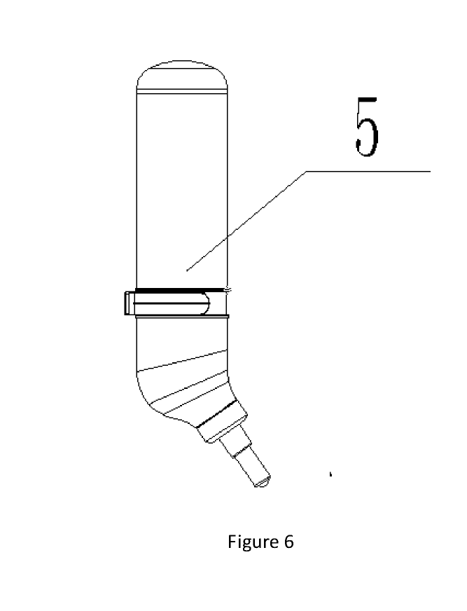

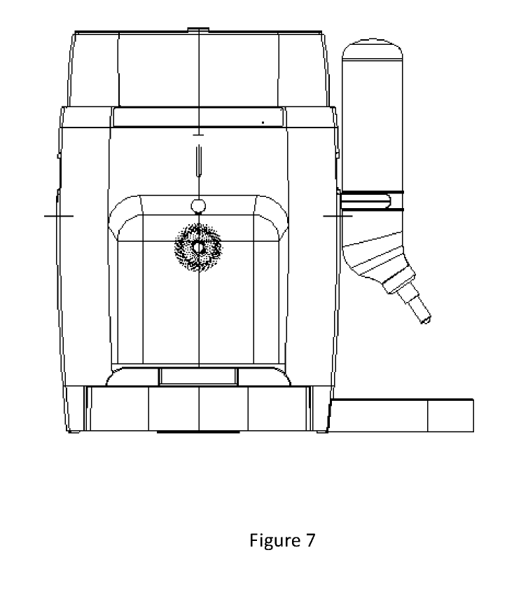

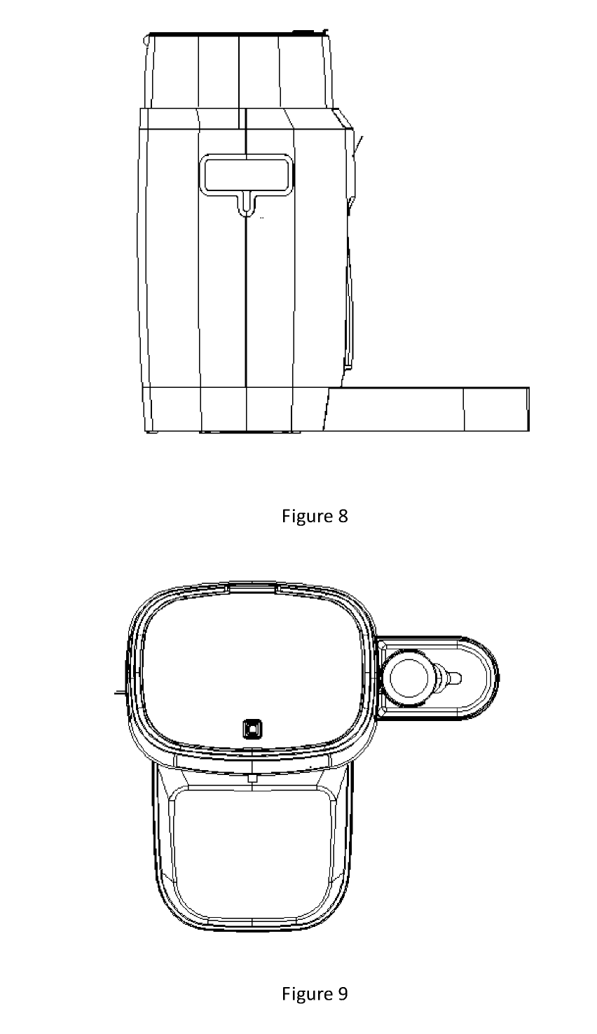

As FIGS. 1-9, a novel pet feeder, which comprises a base (1), a shell body (2), a discharging system (3), a material bucket (4), and a water bottle (5); the base (1) consists of a base shell (1-1), a food disk (1-2) and a water disk (1-3); the front side of the base shell (1-1) is provided with a buckle hook and the buckle hook is plugged in a chute arranged on the food disk (1-2); the shell body (2) is fixed on the base (1); the shell body (2) is composed of a front shell (2-1), a back shell (2-2), a handle (2-3) and a control panel (2-4); both sides of the front shell (2-1) and the back shell (2-2) are provided with installing holes of which dimensions are just matched with the handle (2-3), and the handle (2-3) is just blocked by the combination of the front shell (2-1) and the back shell (2-2); a control panel component (2-4) is fixed on the front shell (2-1); a discharging system (3) is installed inside the shell body (2); the top part of the discharging system (3) is connected with the material bucket (4); a water bottle (5) is fixed on the handle (2-3) through a buckle. The discharging system (3) comprises a discharging bracket (3-1), a discharging roller slot (3-2), a discharging frequency detecting module, a motor, and a motor fixing cover (3-3); the upper end of the discharging bracket (3-1) can be spaced with the material bucket (4) to guarantee the mutual cooperation, food can smoothly enter the top part; the discharging roller slot (3-2) is installed in the cavity body of the discharging bracket (3-1); the discharging frequency detecting module is installed on the discharging opening of the discharging bracket (3-1); a material stirring piece (3-4) is installed in the discharging roller slot (3-2) and rotated under the driving of a motor; a specific rectangular asymmetrical structure of the material stirring piece (3-4) can make the food lay off smoothly; a rotary shaft of the material stirring piece (3-4) is connected with a food feeding counter and a food feeding starter; when the motor is rotated at 45 degrees, the device is triggered to feed; the motor is counted once for every rotation and stops rotation when the preset grid number is reached; a motor protecting cover is arranged on the motor and fixed on the inside of the shell body (2). The material bucket (4) sleeves on the shell body (2), and comprises a bucket cover (4-1), a material bucket light guide arm cover (4-2), a lower material bucket (4-3), and a discharging connection component (4-4); the bucket cover (4-1) is of flip type, and the switch is of pressing retreat type, namely, the button is pressed down and an extended buckle position is internally contracted; meanwhile, the cover is opened and then closed, thus the bucket cover is pressed; the buckle position is buckled again under the spring pressure after the buckle position is internally contracted; the material bucket light guide arm cover (4-2) and the lower material bucket (4-3) are connected through a screw; the lower part of the material bucket light guide arm cover (4-2) is equipped with a light guide pillar and an LED lamp; through the specific angle at 45 degrees, the upper part of the whole material bucket is lighted; the lower material bucket (4-3) is matched with the shell body (2) through the buckle position and the guide groove, and can be taken out in the process of filling food; a silica gel pad is embedded to the upper part of the material bucket light guide arm cover (4-2) for ensuring the tightness in the material bucket. The food disk (1-2) and the water disk (1-3) can be detached for cleaning; the bottom shell (2) is loaded with two power supply methods of three 5# batteries and DC direct plug-in; when the DC direct plug-in stops working, the battery is automatically started to supply power; a water nozzle sleeve of the water bottle (5) is a stainless steel pipe, and two steel beads are placed therein as water outlet switches.

In the embodiment, the utility model has the beneficial effects that the novel pet feeder can carry out remote and accurate feeding control and instant video signaling of good vision by means of a terminal device; meanwhile, the grain discharging condition also can be monitored in real time and effectively controlled, and manual quantitative feeding can be selected. The structure is stable with great road holding performance; the improved material stirring system makes the food discharge more accurately. The effective anti-blocking mechanism can guarantee the normal discharge of food, and carry out self protection under emergency. Moreover, the novel pet feeder can offer multifunctional reasonable feeding and more convenient and smarter pet cultivation way.

The above exhibits and describes the basic principle, main characteristics and advantages of the utility model. The technicians of the industry should understand that the utility model is not limited to the above embodiment, and the embodiment and the specification only elaborate the principle of the utility model; without running out of the spirit and scale of the utility model, the utility model will have various changes and improvements; these changes and improvements are within the scale of the utility model requiring protection. The protection scale of the utility model is defined by the claims attached and its equivalents.

1. A novel pet feeder, which comprises a base, a shell body, a discharging system, a material bucket, and a water bottle; the base consists of a base shell, a food disk and a water disk; the front side of the base shell is provided with a buckle hook, which is plugged in a chute arranged on the food disk; the shell body is fixed on the base; the shell body is composed of a front shell, a back shell, a handle and a control panel; both sides of the front shell and the back shell are provided with installing holes of which dimensions are just matched with the handle, and the handle is just blocked by the combination of the front shell and the back shell; a control panel component is fixed on the front shell; a discharging system is installed inside the shell body; the top of the discharging system is connected with the material bucket; a water bottle is fixed on the handle through a buckle.

2. The novel pet feeder according to claim 1, which is characterized in that the discharging system comprises a discharging bracket, a discharging roller slot, a discharging frequency detecting module, a motor, and a motor fixing cover; the upper end of the discharging bracket can be spaced with the material bucket to guarantee the mutual cooperation, food can smoothly enter the top part; the discharging roller slot is installed in the cavity body of the discharging bracket; the discharging frequency detecting module is installed on the discharging opening of the discharging bracket; a material stirring piece is installed in the discharging roller slot and rotated under the driving of a motor; a specific rectangular asymmetrical structure of the stirring piece can make the food lay off smoothly; a rotary shaft of the material stirring piece is connected with a food feeding counter and a food
feeding starter; when the motor is rotated at 45 degrees, the device is triggered to feed; the motor is counted once for every rotation and stops rotation when the preset grid number is reached; a motor protecting cover is arranged on the motor and fixed on the inside of the shell body.

3. The novel pet feeder according to claim 2, which is characterized in that the material bucket is sleeved on the shell body, and comprises a bucket cover, a material bucket light guide arm cover, a lower material bucket, and a discharging connection component; the bucket cover is of flip type, and the switch is of pressing retreat type, namely, the button is pressed down and an extended buckle position is internally contracted; meanwhile, the cover is opened and then closed, thus the bucket cover is pressed; the buckle position is buckled again under the spring pressure after the buckle position is internally contracted; the material bucket light guide arm cover and the lower material bucket are connected through a screw; the lower part of the material bucket light guide arm cover is equipped with a light guide pillar and an LED lamp; through the specific angle at 45 degrees, the upper part of the whole material bucket is lighted; the lower material bucket is matched with the shell body through the buckle position and the guide groove, and can be taken out in the process of filling food; a silica gel pad is embedded to the upper part of the material bucket light guide arm cover for ensuring the tightness in the material bucket.

4. The novel pet feeder according to claim 1, which is characterized in that the food disk and the water disk can be detached for cleaning; the bottom shell is
provided with two power supply methods of three 5# batteries and DC direct plug-in; when the DC direct plug-in stops working, the battery is automatically started to supply power; a water nozzle sleeve of the water bottle is a stainless steel pipe, and two steel beads are placed therein as water outlet switches.
